(19) United States
(12) Patent Application Publication
(10) Pub. No.: US 2002/0136204 A1
(43) Pub. Date: Sep. 26, 2002

(54) Method and system for routing network traffic based upon application information

(75) Inventors: Li-wen Chen, Cupertino, CA (US); Ron-Chung Hu, Palo Alto, CA (US)

Correspondence Address: Paul A. Durdik, Squire, Sanders and Dempsey L.L.P., 600 Hansen Way, Palo Alto, CA, 94304-1043, US

(73) Assignee: MetaEdge Corporation, Sunnyvale, CA

(21) Appl. No.: 10/072,564

(22) Filed: Feb. 6, 2002

Related U.S. Application Data
(60) Provisional application No. 60/266,966, filed on Feb. 6, 2001.
(60) Provisional application No. 60/303,639, filed on Jul. 5, 2001.
(60) Provisional application No. 60/310,087, filed on Aug. 2, 2001.

(51) Int. Cl. H04L 12/56

(52) U.S. Cl. 370/352; 370/389

(57) ABSTRACT

The present invention provides techniques for routing network traffic based upon application information. Specific embodiments provide users, such as businesspersons or other professionals with the capability to understand relationships among customers or clients, for example, and to manipulate traffic in enterprise network resources based upon these relationships. Various network applications, such as HTTP, SNMP, and the like, are supported by specific embodiments. Content-based routing methods can direct network traffic based on the Uniform Resource Locator (URL), which may contain an HTTP cookie in certain embodiments. Accordingly, novel ways to define the cookie by including the application data obtained from customer data analysis can be used with specific embodiments. Multidimensional models, statistical computations, rule based systems, report generators, and the like can be used with various specific embodiments in order to enable the decision maker to understand, analyze and present relationships among various information entities.

### CROSS-REFERENCES TO RELATED APPLICATIONS

This application claims priority from the following U.S. Provisional Patent Applications, the disclosure of which, including all appendices and all attached documents, is incorporated by reference in its entirety for all purposes:

U.S. Provisional Patent Application Serial No. 60/266,966, to Li-Wen Chen entitled, “METHOD AND APPARATUS FOR ANALYZING CLICK STREAMS,” filed Feb. 6, 2001;

U.S. Provisional Patent Application Serial No. 60/303,639, to Li-Wen Chen, et. al entitled, “METHOD AND APPARATUS FOR ROUTING NETWORK TRAFFIC USING APPLICATION DATA,” filed Jul. 5, 2001; and

U.S. Provisional Patent Application Serial No. 60/310,087, to Li-Wen Chen entitled, “METHOD AND SYSTEM FOR ROUTING NETWORK TRAFFIC” filed Aug. 2, 2001.

### BACKGROUND OF THE INVENTION

The present invention relates generally to techniques for providing decision support, and in particular to techniques for visualizing and relationships among marketing and other business information.

Conventional routing methods are based on the IP address of the destination host computer or the combination of the destination IP address and port number. Since network traffic arrives in many business or other enterprises' servers from customers or clients, business decision makers have become keenly aware of the effects of response time of business on-line assets to the customer's perception of quality level of the business based upon the customer's interacting with these resources. Indeed, proper, efficient routing of customer inquiries, on-line account access, or the like can make or break the business-customer relationship. Conventional technologies approach data routing from the viewpoint of the network, i.e., routing of data is done based upon algorithms designed to balance loads across multiple servers, or provide a lower average wait time.

While certain advantages to conventional approaches are perceived, opportunities for further improvement exist. For example, convention approaches that forward network traffic to-servers to minimize overall response time, or balance loads across multiple servers place the network's needs before those of the customers or the business enterprise. Such methods are not convenient for the business or other enterprise that desires to manage network traffic based upon specific criteria. For example, enterprises may wish to elect to route traffic to different servers based upon the identity of the sender of the traffic, i.e., customer or visitor, for example. Business decision makers have long had access to business decision support technologies that provide tools and techniques for analyzing information about customers, for example. Techniques such as statistics, report generators, such as On Line Analytical Processing (OLAP), and so forth, provide ways for business decision makers to use business information in making business decisions. However, there have been no techniques heretofore known for employing such business intelligence techniques to the problem of routing customer network traffic.

What is needed are improved techniques for routing network traffic.

### SUMMARY OF THE INVENTION

The present invention provides techniques for routing network traffic based upon application information. Specific embodiments provide users, such as businesspersons or other professionals with the capability to understand relationships among customers or clients, for example, and to manipulate network traffic based upon these relationships. Various network applications, such as HTTP, SNMP, and the like, are supported by specific embodiments. Content-based routing methods can direct network traffic based on the Uniform Resource Locator (URL), which may contain an HTTP cookie in certain embodiments. Accordingly, novel ways to define the cookie by including the application data obtained from customer data analysis can be used with specific embodiments. Multidimensional models, statistical computations, rule based systems, report generators, and the like can be used with various specific embodiments in order to enable the decision maker to understand, analyze and present relationships among various information entities.

In a representative embodiment according to the present invention, a system for routing network traffic is provided. The system comprises a content traffic governor (CTG); a content switch; a data source; and an analysis means that analyzes customer data supplied from the data source. The content traffic governor (CTG), in conjunction with the analysis means, sets up traffic routing rules at the content switch (CS) thereby providing routing of network traffic based upon the customer data supplied from the data source.

In a specific embodiment, the system can also include a default web server, so that the content switch routes network traffic lacking a routing cookie to the default web server. In another specific embodiment, the system further comprises a first web server for providing premium level service; and a second web server for providing standard level service. The content switch routes network traffic to one of the first web server and the second web server based upon a determination of a service level appropriate for a sender of the network traffic, the determination being based on the customer data.

In a further specific embodiment of the system, the content traffic governor routes network traffic based upon analyses of at least one of information about a sender of network traffic, a business, a business' customers or relationships underlying any thereof. In various specific embodiment of the system, the information about a sender may be determined from at least one of contents of a packet, an HTTP header, a cookie, a URL.

In another specific embodiment, the system further comprises a user API, from which customers configure parameters for the content traffic governor. The user API may be used to configure at least one of web server names, matching cookie names and values; routing cookie parameters, including name, value, expiration, path, and security type; user ID cookie names and values; C-Insight database table names, and parameters to retrieve client profile data; parameter names and threshold values of client profile database table for generation of routing cookie; and routing table setting.

In a representative embodiment according to the present invention, a method for routing network traffic is provided. The method comprises determining an identity of a sender of a request. Determining a service level based upon the identity is also part of the method. Further, the method includes forwarding the request to resources appropriate for servicing requests of the service level and setting a cookie in a machine sending the request to cause request from that machine to be directed to the appropriate resources. In a specific embodiment, the method also includes modifying configuration to change routing for a group of senders of requests.

In a representative embodiment according to the present invention, a method for routing network traffic is provided. The method comprises receiving a request for content from a client; retrieving a user ID cookie from the request; retrieving a user ID from the user ID cookie; and fetching a routing cookie from the request.

In a representative embodiment according to the present invention, an apparatus for routing network traffic is provided. The apparatus comprises means for determining an identity of a sender of a request; means for determining a service level based upon the identity; means for forwarding the request to resources appropriate for servicing requests of the service level; and means for setting a cookie in a machine sending the request to cause request from that machine to be directed to the appropriate resources. In a specific embodiment, the apparatus can also include a means for modifying configuration to change routing for a group of senders of requests.

In a representative embodiment according to the present invention, an apparatus for routing network traffic is provided. The apparatus comprises a processor; a memory; and at least one network interface. The processor is operative to determine an identity of a sender of a request; determine a service level based upon the identity; forward the request to resources appropriate for servicing requests of the service level; and set a cookie in a machine sending the request to cause request from that machine to be directed to the appropriate resources.

Numerous benefits are achieved by way of the present invention over conventional techniques. Specific embodiments according to the present invention provide techniques for routing network traffic at the application network layer based upon information about the sender. Specific embodiments can collect and report customer defined, multiple dimensional operation statistics and analyze the results, as well as provide application-based Internet traffic routing. The information can be determined from the network packet, an HTTP cookie, the URL of the sender, or any combination thereof. In specific embodiments, routing can be conducted based upon analyses of relationships underlying various information entities, including information about the sender of network traffic, the business, the business' customers or any combination thereof. Specific embodiments provide the capability to an enterprise to freely define customer profiling values. For example, a bank may profile customers using customer account balance, an on-line store may profile customers using spending level, an airline company may profile customers using frequent flier mileage, and the like.

Accordingly, the traffic redirecting rules can be optimized dynamically according to the profile value of a user (i.e., priority of a user). Specific embodiments can provide increased speed for a priority user's request without increasing the bandwidth or changing the server software. For example, an enterprise can reserve some web servers for premium clients in order to speed up system response for them. The premium customers are identified dynamically by analytical software using business rules. For instance, a bank may define the premium customers with account balance more than one million dollars. Since the bank computes account balance on a daily basis, the premium status of a customer must be determined dynamically on a daily basis.

These and other benefits are described throughout the present specification. A further understanding of the nature and advantages of the invention herein may be realized by reference to the remaining portions of the specification and the attached drawings.

### BRIEF DESCRIPTION OF THE DRAWINGS

FIG. 1 illustrates a representative architecture capable of supporting application based network routing application in a specific embodiment of the present invention.

FIG. 2 illustrates representative processing for client access request without routing cookie and user ID cookie in a specific embodiment of the present invention.

FIG. 3 illustrates representative processing for client access request with user ID cookie but without routing cookie in a specific embodiment of the present invention.

FIG. 4 illustrates representative processing for client access request with a routing cookie that matches with User ID in a specific embodiment of the present invention.

FIG. 5 illustrates representative processing for client access request with a routing cookie that does not match with User ID in a specific embodiment of the present invention.

FIG. 6 illustrates representative processing for client access request with routing cookies, but no user ID cookie in a specific embodiment of the present invention.

FIG. 7 illustrates a diagram of representative interfaces for the content traffic governor in a specific embodiment of the present invention.

FIG. 8 illustrates a representative sequence diagram of the content traffic governor (CTG) creating a routing cookie for a client with User ID in a specific embodiment of the present invention.

FIG. 9 illustrates a representative data flow diagram for configuration of parameters in a specific embodiment of the present invention.

FIG. 10 illustrates a representative diagram of a process for creating a routing cookie in a specific embodiment of the present invention.

FIG. 11 illustrates a representative diagram of a customer user interface options in a specific embodiment of the present invention.

FIG. 12 illustrates a representative computer system suitable for implementing a specific embodiment of the present invention.

### DESCRIPTION OF THE SPECIFIC EMBODIMENTS

The present invention provides techniques for routing network traffic based upon application information. Specific embodiments provide users, such as businesspersons or other professionals with the capability to understand relationships among customers or clients, for example, and to manipulate traffic in enterprise network resources based upon these relationships. Various network applications, such as HTTP, SNMP, and the like, are supported by specific embodiments. Content-based routing methods can direct network traffic based on the Uniform Resource Locator (URL), which may contain an HTTP cookie in certain embodiments. Accordingly, novel ways to define the cookie by including the application data obtained from customer data analysis can be used with specific embodiments. Multidimensional models, statistical computations, rule based systems, report generators, and the like can be used with various specific embodiments in order to enable the decision maker to understand, analyze and present relationships among various information entities.

Specific embodiments of the present invention provide a closed loop content analysis and routing management application that retrieves SNMP/MIB and RMON data from a content switch for C-Insight Engine to analyze, and to generate customer defined reports. Using the features of C-INSight, users can create virtual schema and impose these virtual schema onto data stored in the data warehouse. Further, features such as report generation, and the like are based upon the user's virtual schema, enabling fast efficient understanding of business intelligence underlying the data in the data warehouse. Specific embodiments employ C-INSight™, a product of MetaEdge Corporation, of Sunnyvale, California, to provide the capability to dynamically derive attributes and profiles from static data. However, the present invention is not limited embodiments in which the client profile data source is C-INSight. The reports cover the traffic of the entire networks under content switch, instead of a single server.

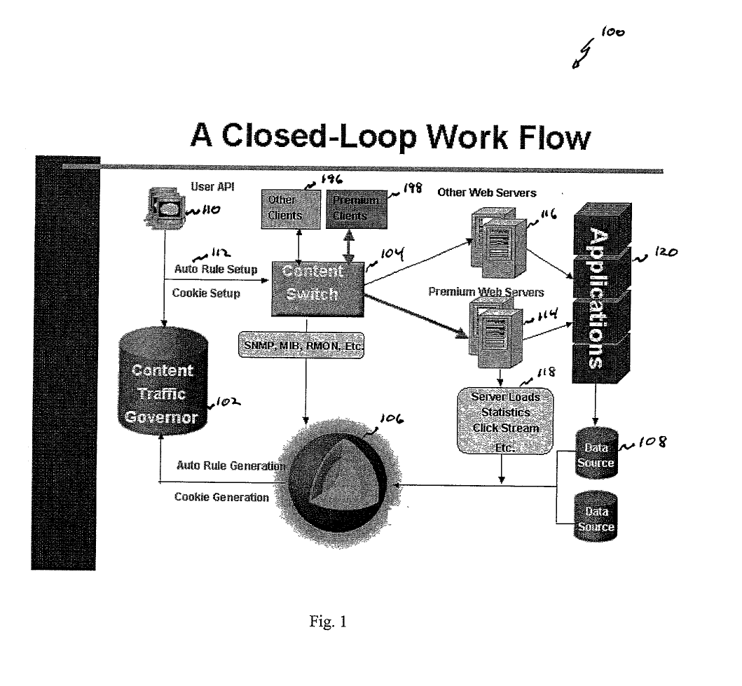

FIG. 1 illustrates a representative architecture capable of providing application based routing in a specific embodiment of the present invention. Application-based routing means that traffic can be routed by client profile, Web content, application of the content, or combination thereof. The application-based routing is developed on the layer 5 routing capability of content switch that can route client request based on matching of the layer 5 information of URL, cookie, and SSL session ID. As shown by FIG. 1, an architecture diagram 100 comprises of a content traffic governor (CTG) 102, which makes use of analytical software 106 to analyze customer data supplied from data source 108, and then sets up traffic routing rules on a content switch (CS) 104. In specific embodiments, the content traffic governor 102 can manipulate the traffic routing for the system shown in FIG. 1 using a variety of methods, including: 1. setting cookies on a client computer (not shown) according to the profile of the client. The cookies provide a mechanism for assuring that the request from the client computer is routed to a target server defined in content switch configuration; and 2. modifying content switch configurations dynamically to change routing for entire or a group of clients.

In the specific embodiment illustrated by FIG. 1, a cookie in HTTP header can be defined to include customer identification information, such as a client's profile value, and the expiration date using an application interface for the content traffic governor application programming interface (CTG API) 110. As used herein, the term “cookie” is used to refer to an HTTP header that comprises of a text-only string that gets entered into the memory of a browser. This string contains the domain, path, lifetime, and value of a variable that a website sets. If the lifetime of this variable is longer than the time the client spends at that site, then this string is saved to a file for future reference. Content switch 104 is operative to discern between network traffic from premium clients 198 and other clients 196 based upon the information stored in the cookie, HTTP, sender's URL, message content or any combination thereof. Thereupon, content switch 104 routes network traffic to one or the other of premium web servers 114, for premium clients 198, or to other web servers 116 for other clients 196. Further, premium web servers 114 and other web servers 116 have access to one or more applications 120 which premium clients 198 and other clients 196 may be permitted access. When a client request 198 arrives with a valid HTTP cookie, as verified by the content switch 104, the traffic is routed to the corresponding web server 114. The client's traffic will continue to be routed to the web server 114 as long as the cookie is not expired. Data 118 may be collected by premium web servers 114, other web servers 11 6, or both, for inclusion into data source 108. After collecting customer data from the predefined data sources and computing the clients' profile values based on an enterprise's business rules, the analytical software 106 can push the analysis results (i.e., the client profile values) to content traffic governor 102.

In specific embodiments, the users' network traffic may be routed based on information stored within HTTP cookies, such as the client profile values configured by the customer, for example. It should be noted that enterprises are free to define client profile values for its clients. For example, a bank may profile clients using client account balance, an on-line store may profile clients using spending level, an airline company may profile clients using frequent flier mileage, and so forth. It is noteworthy that cookies are not required to practice other specific embodiments of the invention. Accordingly, the embodiment illustrated by FIG. 1 and following is merely representative of a plurality of possible implementations evident to those skilled in the art having reference to the teachings herein.

In specific embodiments, the traffic redirecting rules can be optimized dynamically according to the profile value of a client (i.e., priority of a client). Accordingly, in specific embodiments, a priority client's request may be provided expedited processing without increasing the bandwidth or changing the server software. For example, an enterprise can reserve some web servers for premium clients in order to speed up system response time for these clients. The premium clients are identified dynamically by analytical software using business rules. For example, a bank may define the premium clients with account balance more than one million dollars. Since the bank computes account balance on a daily basis, the premium status of a client must be determined dynamically on a daily basis. This is provided by the analytical software 106 performing updates to the client's profile on a repetitive basis.

The content traffic governor 102 depends on client identifications to route client request to desired Web servers. The client identifications may exist in the forms of HTTP cookies, URL query string, or combination thereof for example in various specific embodiments. For simplicity, the present invention will be described with reference to example embodiments in which the identifications exist as cookies on computers of clients. The techniques that work with cookies can be implemented using other identification formats, as will be readily apparent to those skilled in the art with reference to the teachings herein. In some embodiments, customers can actually specify all the identification related information in content traffic governor 102, which will be described herein below.

In a specific embodiment, cookies can include user ID cookies and routing cookies. Web servers create the user ID cookie. The purpose of this cookie is to let content traffic governor 102 know the client identification. Either a unique name such as “meta-cam-client” may be assigned to clients, or customers may be enabled to give a name to this cookie. The name should be unique to each customer since one content traffic governor 102 may govern more than one customer. The value of the cookie should be the User ID of a client. Web server applications usually assign some identification in cookie to a client at certain stage, such as after successful login. When the client sends request to the Web server next time, the Web server can recognize the client from the cookie. If a customer already assigns a User ID as a cookie to a client, the customer just needs to make another one with the given or chosen cookie name. If a customer does not already have the mechanism of creating the user ID cookie, a JavaScript code can be provided to in the Web pages to create user ID cookie for customers.

The content traffic governor 102 creates the routing cookie. The routing cookie indicates what Web servers the client should be connected with. There may be more than one routing cookie for each customer. The names for the routing cookies should match with the identifiers given to the corresponding servers in content switch configuration. The value of a routing cookie could be the corresponding routing cookie. Routing cookies are generated based on client profile data, content switch configuration, and content traffic governor 102 configuration.

### Routing Client Requests

Specific embodiments of the present invention will now be explained with reference to a variety of examples of routing client requests for services using content switching advanced-balance techniques. The following scenarios are merely illustrative of the wide variety of application based network routing techniques provided in the various specific embodiments of the present invention. Accordingly, the following examples are intended to be illustrative rather than limiting of the present invention.

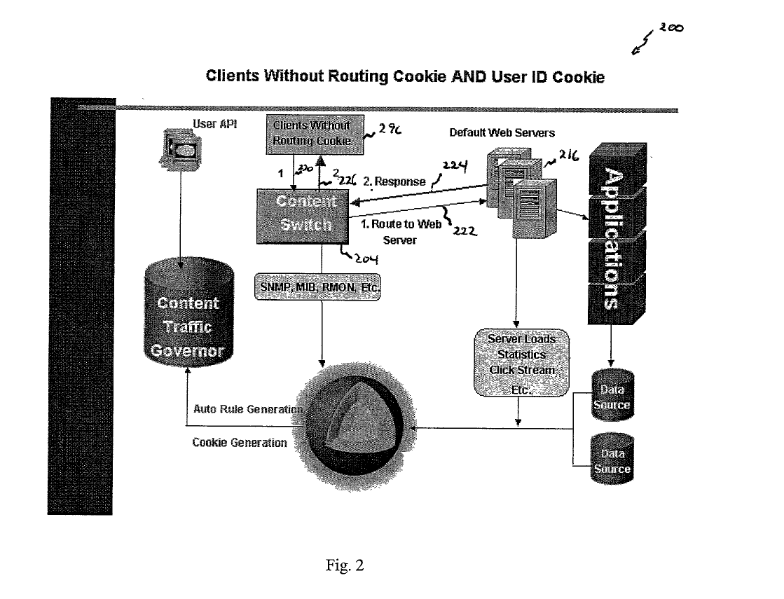

FIG. 2 illustrates representative processing for client access request without routing cookie and a user ID cookie in a specific embodiment of the present invention. As shown in diagram 200 of FIG. 2, a request for content from client 296 is received at content switch 204 in step 220. The request from the client 296 is routed to assigned default web servers 216 by content switch 204 in step 222. With content switch configuration set to the default web servers 216, requests are going to be routed to the default web server 216 having a particular IP address incorporated into the content switch configuration information. Responses from the default web server 216 are routed to the content switch 204 in a step 224. The content switch 204 routes the response back to the client 296 in a step 226. This routing will continue until the User ID of the client 296 becomes available, upon which time the Web server 216 sets the user ID cookie on the computer of the client 296.

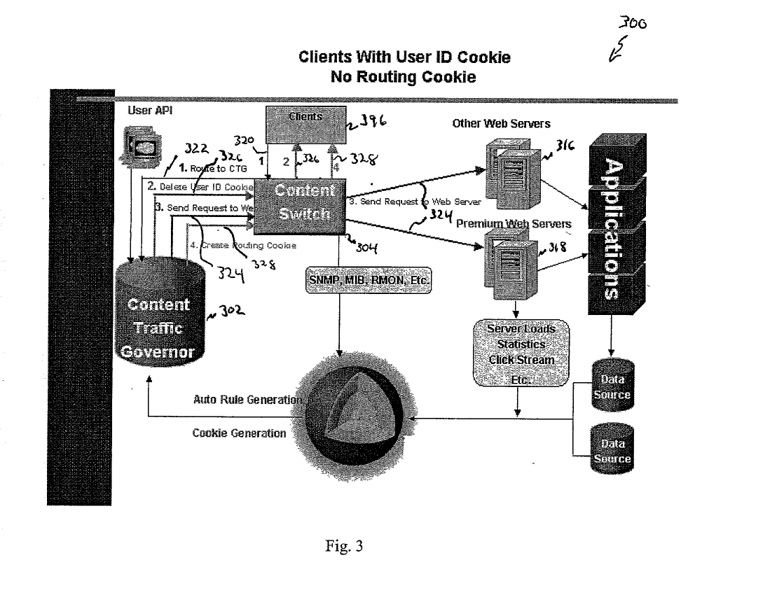

FIG. 3 illustrates representative processing for client access request with user ID cookie but without routing cookie in a specific embodiment of the present invention. FIG. 3 illustrates diagram 300 in which a request for content from client 396 is received at content switch 304 in step 320. The content switch 304 routes all client requests with a user ID cookie to the content traffic governor 302 in step 322. The content traffic governor 302 retrieves a User ID from the user ID cookie, and attempts to fetch the corresponding routing cookie ID from the routing table (not shown) according to the User ID. If the client request does not contain a routing cookie, then the content traffic governor 302 fetches the routing cookie from the routing table (not shown) based on the routing cookie ID. The content traffic governor 302 then redirects the client request to the corresponding Web server 316, 318 in a step 324. The content traffic governor 302 deletes the user ID cookie in a step 326. Further, the content traffic governor 302 sets up the routing cookie on client computer 396 in a step 328.

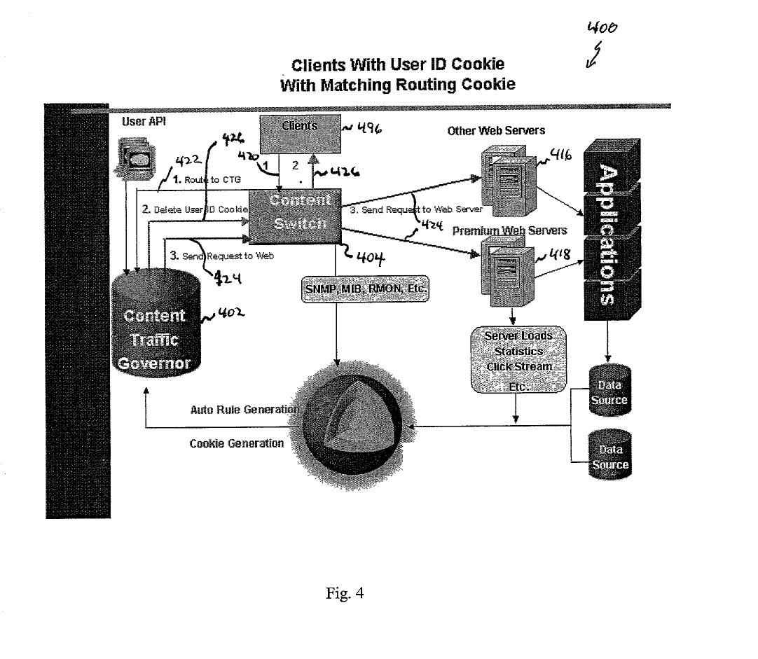

FIG. 4 illustrates representative processing for client access request with a routing cookie that matches with User ID in a specific embodiment of the present invention. FIG. 4 illustrates diagram 400 in which a request for content from client 496 is received at content switch 404 in step 420. The content switch 404 routes all client requests with a user ID cookie to the content traffic governor 402 in step 422. The content traffic governor 402 retrieves a User ID from the user ID cookie, and attempts to fetch the corresponding routing cookie ID from the routing table (not shown) according to the User ID. If the client request contains a routing cookie, then the content traffic governor 402 gets the routing cookie ID from the routing cookie of the request, and compares it with the routing cookie ID based on the User ID. If the two routing cookie IDs are the same, then the content traffic governor 402 redirects the request to corresponding Web server 416, 418 through content switch 404, and deletes the User ID cookie on the client computer 496 in a step 426.

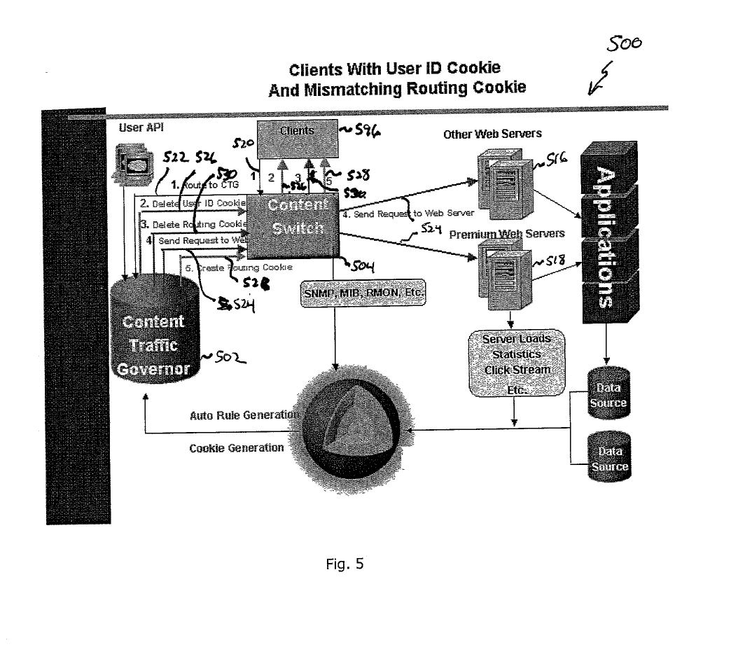

FIG. 5 illustrates representative processing for client access request with a routing cookie that does not match with User ID in a specific embodiment of the present invention. FIG. 5 illustrates diagram 500 in which a request for content from client 596 is received at content switch 504 in step 520. The content switch 504 routes all client requests with a user ID cookie to the content traffic governor 502 in step 522. The content traffic governor 502 retrieves a User ID from the user ID cookie, and attempts to fetch the corresponding routing cookie ID from the routing table (not shown) according to the User ID. If the two routing cookie IDs are different, content traffic governor 502 deletes the user ID cookie in a step 526, and deletes the existing routing cookie in a step 530. The content traffic governor 502 creates a new routing cookie for the client in a step 528, and redirects the request to corresponding Web server 516, 518 through content switch 504 in a step 524. This way it solves the dilemma caused by a new client uses another client computer to access the same web services.

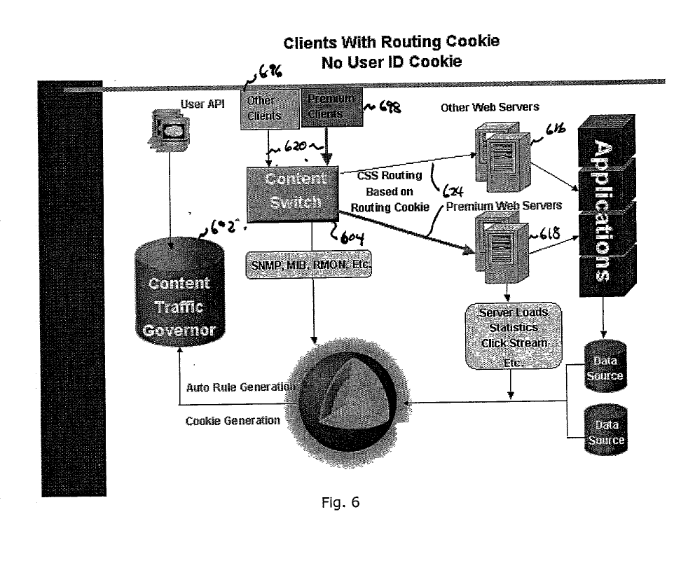

FIG. 6 illustrates representative processing for client access request with routing cookies, but no user ID cookie in a specific embodiment of the present invention. FIG. 6 illustrates diagram 600 in which a request for content from a client 596, 598 is received at content switch 604 in step 620. The content switch 604 routes the requests to the Web servers 616, 618 according to the routing cookies in a step 624.

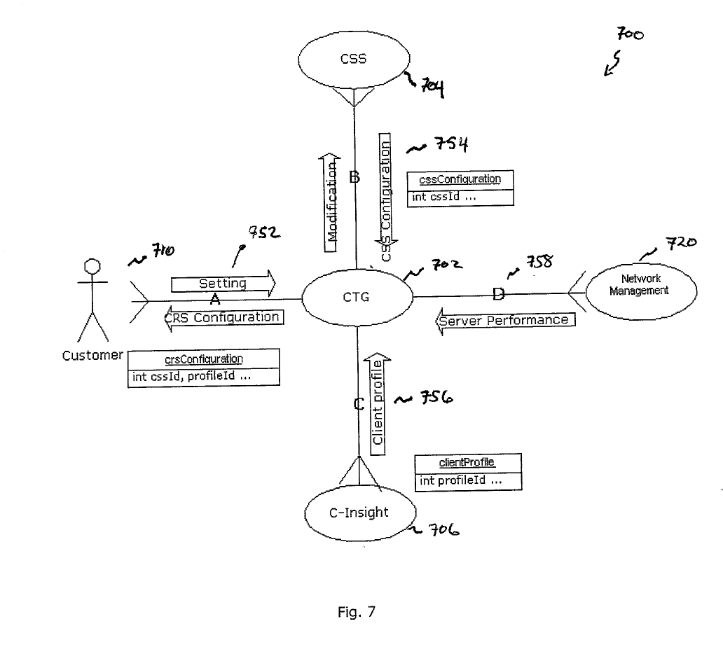

FIG. 7 illustrates a diagram of representative interfaces for the content traffic governor in a specific embodiment of the present invention. FIG. 7 shows diagram 700 of four interfaces within content traffic governor (CTG) 702 that enable exchange of information between content traffic governor (CTG) 702 and Customers 710, content traffic governor (CTG) 702 and C-Insight 706, content traffic governor (CTG) 702 and content switch 704, and content traffic governor (CTG) 702 and Network Management Devices 720, respectively. In a specific embodiment, these interfaces provide handling of one-to-many relationships, and possible expansion to different networking devices, and different client profile data providers, for example.

The content traffic governor (CTG)-Customer interface 752 provides customer access to the setup capabilities of the content traffic governor (CTG) 702, and presents content traffic governor (CTG) configuration data to the customer. In a specific embodiment, a Web browser provides the content traffic governor (CTG)-Customer interface 752.

Since in specific embodiments there can be one-to-many CTG-Customer, CTG-content switch, CTG-C-Insight, and CTG-Network Management Devices relationships, the Customer ID, content switch object ID, C-Insight ID, and Network Management Device ID may be keyed on CTG configuration objects. Therefore each CTG configuration object represents its own Customer, content switch, C-Insight, and Network Management Device objects in such embodiments.

The content traffic governor (CTG)-Content switch interface 754 delivers content switch configuration data to the content traffic governor (CTG) 702, and passes configuration modification commands to content switch. In a specific embodiment, an HTTP-based interface provides the content traffic governor (CTG)-Content switch interface 754. In another embodiment, XML or SOAP content switch interface may be used to pass the information through the content switch Web interface.

In a specific embodiment, the content traffic governor (CTG)-Content switch interface 754 is a one-to-many type interface. One content traffic governor (CTG) may control more than one content switch, even more than one type of networking devices. Device ID and content switch sequence ID are keyed on content switch configuration objects in this embodiment.

The content traffic governor (CTG)-C-Insight interface 756 delivers client profile data from C-Insight to CTG. In a specific embodiment, this interface provides a one-way interface for information flow. The relationship between content traffic governor (CTG) 702 and C-Insight 706 is one-to-many. It is noteworthy that client profile data may come from sources other than C-Insight. Furthermore, the data passed into content traffic governor (CTG) 702 from the interface 756 may not be limited to client profiles. Other types of data may be used as well, as long as the data can be used to help route Internet traffic. However, “client profile” is still used to represent the data that are passed into content traffic governor (CTG) 702 from the interface 756. Object IDs of data type, data source, and sequence of the data source are all keyed on the client profile objects.

The content traffic governor (CTG)-Network Management Devices interface 758 delivers Web server performance information from Network Management Devices to content traffic governor (CTG) 702. The CTG can then modify content switch configuration to approach near real-time optimization.

Specific embodiments of the present invention comprise a core software package. The core package generates and updates the CTG routing tables. There is a one-to-one relationship between CTG configuration and the routing table.

Specific embodiments of the present invention comprise a delegating software package. The software of this package delegates Internet traffic in operation. Its responsibilities include finding information from inbound requests, retrieving routing table information, and deleting and setting up cookies if necessary. Further, in a specific embodiment, software that forwards client requests from CTG to Web servers can be included.

Specific embodiments of the present invention comprise a database. The CTG has its own database to save client profile, CTG configuration, content switch configuration, and other data in specific embodiments.

In a specific embodiment, there may be more than one customers in each CTG. Accordingly, the routing table may be customer specific. Customer ID is keyed to the routing table object. The CTG locates the corresponding routing table for an inbound request based on the customer ID that either is related to the destination URL or IP, or is the URL or IP, for example.

In a specific embodiment, each CTG routing table comprises of two parts. One part includes the parameters for routing cookies. The other part includes the relationship between User IDs and routing cookie IDs. In some specific embodiments, the entire routing table may be loaded in CTG memory to speed up CTG performance. If the number of the unique User IDs is too large to be loaded in the memory, the second part of the routing table is saved in the CTG database. During operation, CTG first retrieves the routing cookie ID based on the User ID of an inbound client request. If necessary, CTG then fetches the parameters for the routing cookie based on the routing cookie ID.

In a specific embodiment, the routing table is pre-generated based upon client profile data, CTG setting, and content switch configuration, or any combination thereof.

In a specific embodiment, multi-threading can be used in code development for the performance critical part of CTG software.

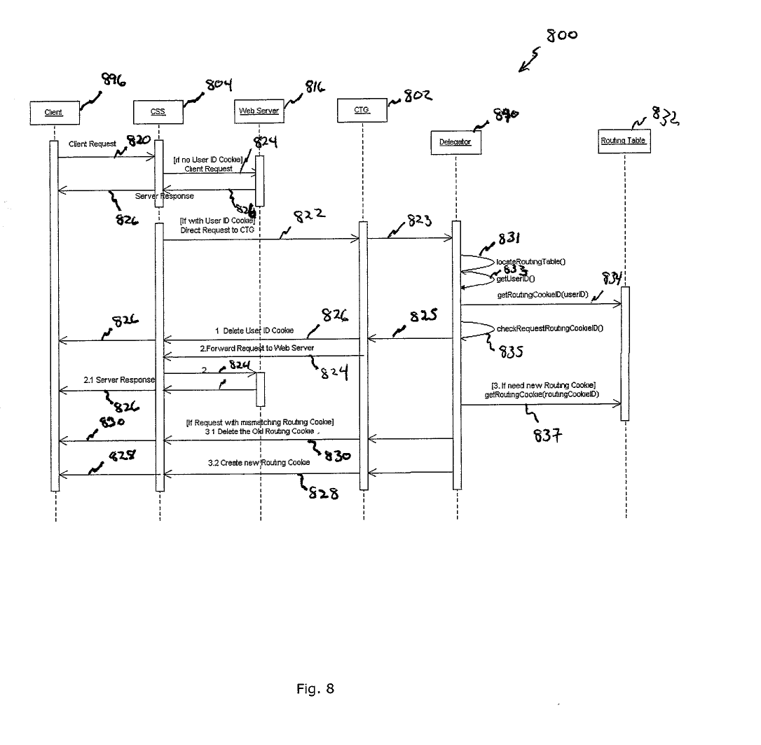

FIG. 8 illustrates a representative sequence diagram of the content traffic governor (CTG) creating a routing cookie for a client with User ID in a specific embodiment of the present invention. FIG. 8 illustrates diagram 800 depicting a plurality of timing relationships between a client 896, a content switch 804, a content traffic governor 804, a web server 816, a delegator 890 and a routing table 832. In diagram 800, a request for content from client 896 is received at content switch 804 in step 820. The content switch 804 routes all requests that have no user ID cookie to web server 816 in a step 824. The web server handles the request, providing a response 826. Alternatively, if the request includes a user ID cookie, then the content switch 804 routes the client request with the user ID cookie to the content traffic governor 802 in step 822. The content traffic governor 802 forwards the request to delegator 890 in a step 823. The delegator 890 checks a local routing table 832 in a step 831. Then, the delegator 890 retrieves a User ID from the user ID cookie in a step 833. Next, the delegator 890 attempts to fetch the corresponding routing cookie ID from the routing table 832 according to the User ID in a step 834. In a step 835, the delegator determines whether the two routing cookie IDs are different. If so, then in a step 825, the delegator so informs the content traffic governor 802, which deletes the user ID cookie in a step 826. The content traffic governor 802 redirects the request to corresponding Web server 816 in a step 824. The server 816 may make a server response to the request in a step 826. If in step 835, it is determined by the delegator 890 that a new routing cookie is needed, then in a step 837, the routing table 832 is checked for a new routing cookie. The delegator 890 sends a request to delete the old routing cookie via the content traffic governor 802 in a step 830. Further, the delegator 890 sends a create new routing cookie request via the content switch 804 to the client 896 in a step 828.

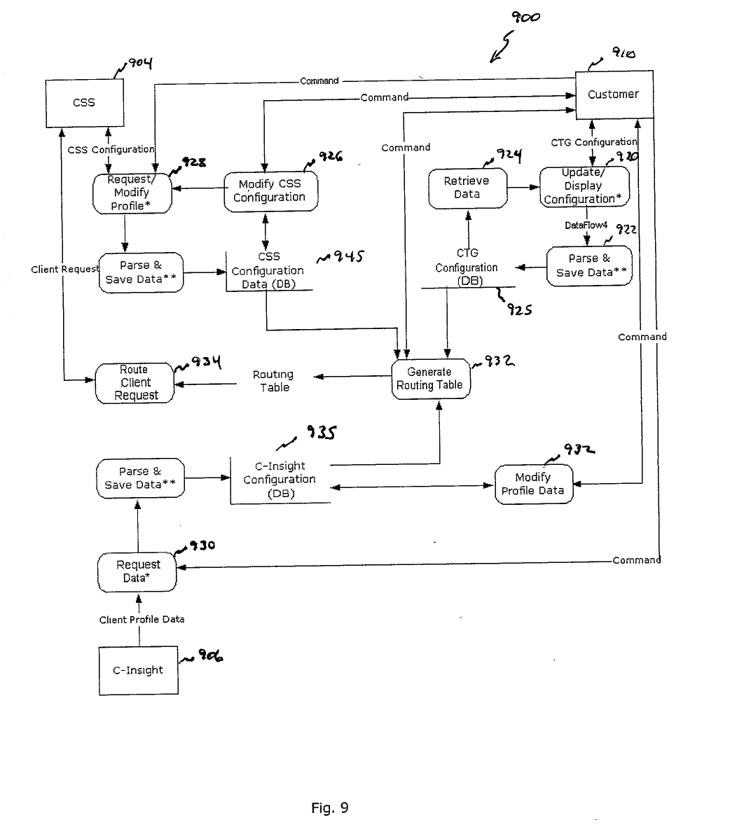

FIG. 9 illustrates a representative data flow diagram for configuration of parameters in a specific embodiment of the present invention. FIG. 9 illustrates some of a wide variety of configurable parameters available to the customer via the customer user interface 910. It is noteworthy that each Data Store in the diagram may contain more than one database table.

In representative specific embodiments of the present invention, customers can configure a variety of parameters for the content traffic governor 902, as illustrated by dataflow 920, 922, 924 and CTG configuration database 925. In a specific embodiment, the Web browser API 910 may be used to configure one or more of the content traffic governor 902 parameters. Among the many parameters that can be configured in specific embodiments of the present invention, a representative list from which one or more may be selected includes: web server names, matching cookie names and values; routing cookie parameters, including name, value, expiration, path, and security type; user ID cookie names and values; C-Insight database table names, and parameters to retrieve client profile data; parameter names and threshold values of client profile database table for generation of routing cookie; and routing table setting.

In representative specific embodiments of the present invention, customers can retrieve content switch configuration data as shown by dataflow 928. Further, in some embodiments, users may configure client profile data, as shown by 930. Customers can either log on to content traffic governor 902 to retrieve these data, or set up time triggered processes “chron jobs” to schedule to poll the data automatically.

In representative specific embodiments of the present invention, customers can create client routing cookies. Customers can create or update parameters of the cookies by either explicitly executing corresponding program on the content traffic governor 902 browser interface, or setting up automatic routings to be triggered by the changes of client profile, content switch configuration, or content traffic governor 902 setting.

In representative specific embodiments of the present invention, customers can set up correlation between routing cookies and Web servers as shown by 932 and 934. Customers can set up the correlations by selecting a Web server string value that is defined in content switch configuration to be the corresponding routing cookie name.

In representative specific embodiments of the present invention, customers can modify content switch configuration as shown by 926. Customers can either explicitly execute a program on the browser interface to modify content switch configuration, or set up parameters to activate an automatic routing to update the configuration on content switch when there is any related change in the content traffic governor 902.

In representative specific embodiments of the present invention, customers can create/update the routing table in the content traffic governor 902. Customers can either explicitly execute a program on the browser interface to create or update the routing table in the content traffic governor 902, or set up parameters to activate an automatic routing to create or update the routing table when there is any related change in the content traffic governor 902.

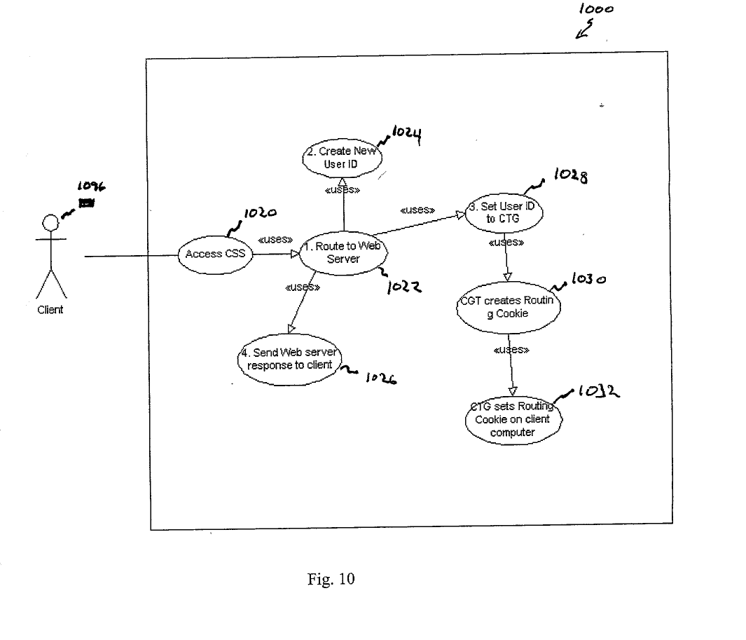

FIG. 10 illustrates a representative diagram of a process for creating a routing cookie in a specific embodiment of the present invention. In diagram 1000, a client 1096 requests access via the content switch 1004 as shown by 1020. The client's request is routed to a web server (not shown) as shown by 1022. A new user ID can be created 1024, the web server (not shown) can send a response to the client as shown by 1026. Further, the user ID can be set up for the content traffic governor (not shown) as shown by 1028. Accordingly, the content traffic governor (not shown) can create a routing cookie 1020. The content traffic governor (not shown) sets the routing cookie on the client computer 1032.

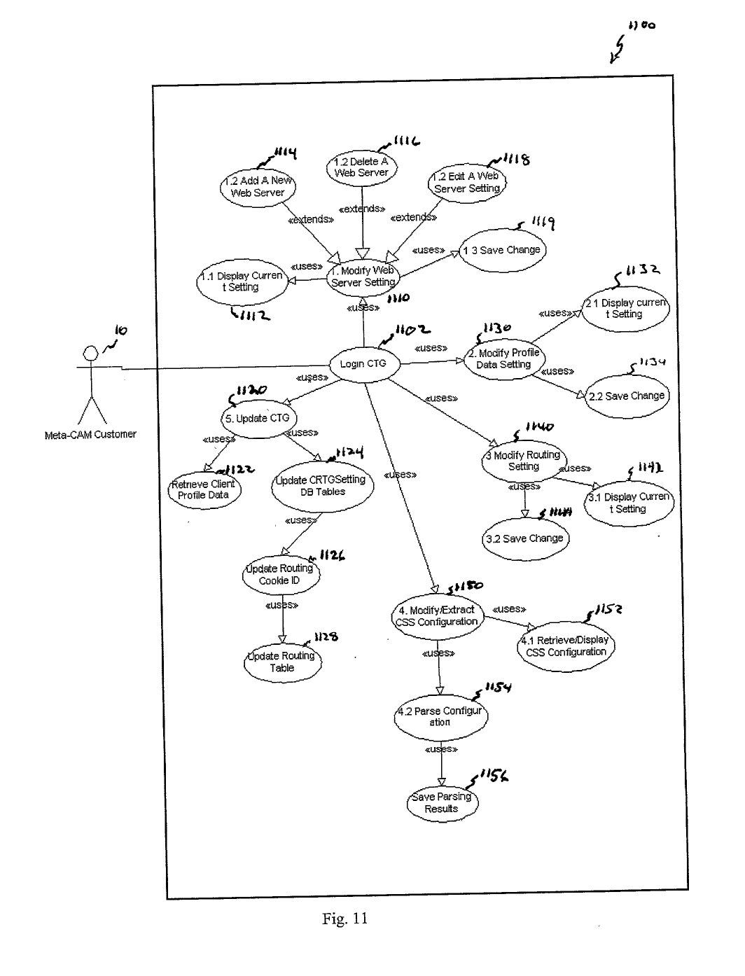

FIG. 11 illustrates a representative diagram of a customer user interface options in a specific embodiment of the present invention. As diagram 1100 shows, a customer 10 can access a variety of functions after completing a login process at the content traffic governor 1102. Customer 10 can modify web server settings 1110, including displaying current settings 1112, adding a new web server 1114, deleting a web server 1116, editing a web server setting 1118, and saving changes 1119.

The customer 10 can also update the content traffic governor 1120, including retrieving client profile data 1122, updating settings in CTG database tables 1124, updating routing cookie Ids 1126, and updating the routing table 1128.

Further, the customer can modify profile data settings 1130, including displaying current settings 1132 and saving changes 1134. The customer can also modify routing settings 1140, such as displaying current settings 1142 and saving changes 1144. Yet further, the customer can modify/extract content switch configurations 1150, including retrieving/displaying configuration 1152, parsing configuration 1154, and saving the parsing results 1156.

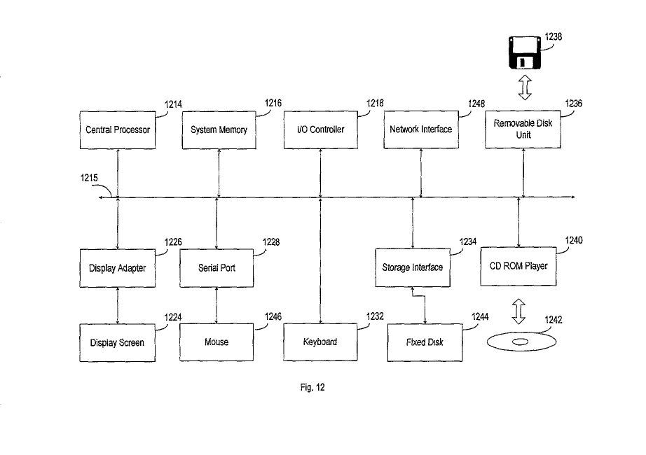

FIG. 12 illustrates a representative computer system suitable for implementing a specific embodiment of the present invention. As shown in FIG. 12 a computer system 1202 suitable for embodying a specific embodiment of the invention. Computer system 1202 includes a bus 1215, which interconnects a variety of components and subsystems. Bus 1215 interconnects a central processor 1214, a system memory 1216, an input/output controller 1218, a display screen 1224 via a display adapter 1226, a serial port 1228, a keyboard 1232, a fixed disk drive 1244 via storage interface 1234, and a removable disk drive 1236. Removable disk drive 1236 is operative to receive a removable disk 1238. Many other devices may be connected to bus 1215. For example, an external device such as a printer (not shown), and/or a scanner (not shown) may be connected via an I/O controller 1218. Mouse 1246 can be connected to serial port 1228. A network interface 1248 can be included to provide connectivity to one or more networks, including the Internet. Many other devices and subsystems (not shown) may be connected in a similar manner. Also, it is not necessary for all of the devices shown in FIG. 12 to be present to practice the present invention. Further, the devices and subsystems may be interconnected in different ways from that shown in FIG. 12 in various specific embodiments. Source code to implement the present invention may be operatively disposed in system memory 1216 and/or stored on storage media such as fixed disk 1244 or removable disk 1238.

The following is a representative example of a configuration definition useful in a specific embodiment of the present invention.

### Content Switch Configuration Sample

!************************** SERVICE **************************

service darmir

ip address 64.169.86.22

keepalive type http

string darmir

active

service darwin

ip address 64.169.86.21

keepalive type http

string darwin

active

!**************************** EQL *****************************

eql metaedge

extension html “for *.html files”

extension htm “for *.htm files”

extension asp “for *.asp files”

!*************************** OWNER ***************************

owner demo

content L3_rule

vip address 64.169.86.7

add service darwin

active

content L5_cookieurl

vip address 64.169.86.7

advanced-balance cookieurl

add service darwin

add service darmir

protocol tcp

port 80

url“/*” eql metaedge

active

The preceding has been a description of the preferred embodiment of the invention. It will be appreciated that deviations and modifications can be made without departing from the scope of the invention, which is defined by the appended claims. The diagrams included herein are merely an illustration of specific embodiments and should not limit the scope of the claims herein. One of ordinary skill in the art would recognize other variations, modifications, and alternatives.

What is claimed is:

1. A system for routing network traffic, comprising:
a content traffic governor (CTG);
a content switch;
a data source;
an analysis means that analyzes customer data supplied from the data source; and
wherein the content traffic governor (CTG), in conjunction with the analysis means, sets up traffic routing rules at the content switch (CS) thereby providing routing of network traffic based upon the customer data supplied from the data source.

2. The system of claim 1, further comprising:
a default web server;
wherein the content switch routes network traffic lacking a routing cookie to the default web server.

3. The system of claim 1, further comprising:
a first web server for providing premium level service; and
a second web server for providing standard level service;
wherein the content switch routes network traffic to one of the first web server and the second web server based upon a determination of a service level appropriate for a sender of the network traffic, the determination being based on the customer data.

4. The system of claim 1, wherein:
the content traffic governor routes network traffic based upon analyses of at least one of information about a sender of network traffic, a business, a business' customers or relationships underlying any thereof.

5. The system of claim 4, wherein the information about a sender may be determined from at least one of contents of a packet, an HTTP header, a cookie, a URL.

6. The system of claim 1, further comprising a user API, from which customers configure parameters for the content traffic governor.

7. The system of claim 6, wherein the user API may be used to configure at least one of web server names, matching cookie names and values; routing cookie parameters, including name, value, expiration, path, and security type; user ID cookie names and values; C-Insight database table names, and parameters to retrieve client profile data; parameter names and threshold values of client profile database table for generation of routing cookie; and routing table setting.

8. A method for routing network traffic, comprising:
determining an identity of a sender of a request;
determining a service level based upon the identity;
forwarding the request to resources appropriate for servicing requests of the service level; and
setting a cookie in a machine sending the request to cause request from that machine to be directed to the appropriate resources.

9. The method of claim 8, further comprising:
modifying configuration to change routing for a group of senders of requests.

10. A method for routing network traffic, comprising:
receiving a request for content from a client;
retrieving a user ID cookie from the request;
retrieving a user ID from the user ID cookie; and
fetching a routing cookie from the request.

11. The method of claim 10, further comprising:
fetching a routing cookie from another source if the request does not contain the routing cookie;
redirecting the request to a web server;
deleting the user ID cookie; and
setting the routing cookie on a client computer source of the request.

12. The method of claim 10, further comprising:
retrieving the routing cookie ID from the routing cookie of the request;
comparing the routing cookie ID from the routing cookie of the request with the routing cookie ID from the user ID;
deleting the user ID cookie at a client computer source of the request if the routing cookie ID from the routing cookie of the request with the routing cookie ID from the user ID are the same, and
redirecting the request to a web server based upon the routing cookie ID.

13. The method of claim 12, further comprising:
deleting the routing cookie and creating a new routing cookie for the client computer if the routing cookie ID from the routing cookie of the request with the routing cookie ID from the user ID are different.

14. A computer program product, comprising a computer readable storage medium for holding:
code that determines an identity of a sender of a request;
code that determines a service level based upon the identity;
code that forwards the request to resources appropriate for servicing requests of the service level; and
code that sets a cookie in a machine sending the request to cause request from that machine to be directed to the appropriate resources.

15. The computer program product of claim 14, further comprising:
code that modifies configuration to change routing for a group of senders of requests.

16. A computer program product, comprising a computer readable storage medium for holding:
code that receives a request for content from a client;
code that retrieves a user ID cookie from the request;
code that retrieves a user ID from the user ID cookie; and
code that fetches a routing cookie from the request.

17. The computer program product of claim 16, further comprising:
code that fetches a routing cookie from another source if the request does not contain the routing cookie;
code that redirects the request to a web server;
code that deletes the user ID cookie; and
code that sets the routing cookie on a client computer source of the request.

18. An apparatus for routing network traffic, comprising:
means for determining an identity of a sender of a request;
means for determining a service level based upon the identity;
means for forwarding the request to resources appropriate for servicing requests of the service level; and
means for setting a cookie in a machine sending the request to cause request from that machine to be directed to the appropriate resources.

19. The apparatus of claim 18, further comprising:
means for modifying configuration to change routing for a group of senders of requests.

20. An apparatus for routing network traffic, comprising:
a processor;
a memory; and
at least one network interface;
wherein said processor is operative to determine an identity of a sender of a request; determine a service level based upon the identity; forward the request to resources appropriate for servicing requests of the service level; and set a cookie in a machine sending the request to cause request from that machine to be directed to the appropriate resources.
